(19) United States
(12) Patent Application Publication
(10) Pub. No.: US 2024/0006101 A1
(43) Pub. Date: Jan. 4, 2024

(54) PRODUCTION METHOD FOR PHOSPHATE-COATED SmFeN-BASED ANISOTROPIC MAGNETIC POWDER AND PHOSPHATE-COATED SmFeN-BASED ANISOTROPIC MAGNETIC POWDER

(71) Applicant: NICHIA CORPORATION, Anan-shi (JP)

(72) Inventors: Masahiro ABE, Tokushima-shi (JP); Satoshi YAMANAKA, Tokushima-shi (JP); Shuichi TADA, Komatsushima-shi (JP); Kenta IWAI, Anan-shi (JP); Takayuki YANO, Tokushima-shi (JP)

(73) Assignee: NICHIA CORPORATION, Anan-shi (JP)

(21) Appl. No.: 18/253,534

(22) PCT Filed: Sep. 30, 2021
(86) PCT No.: PCT/JP2021/036175

§ 371 Date: May 18, 2023

(30) Foreign Application Priority Data
Nov. 18, 2020 (JP) 2020-191743
Nov. 19, 2020 (JP) 2020-192544
Dec. 3, 2020 (JP) 2020-201164

(51) Int. Cl. H01F 1/059; H01F 1/055

(52) U.S. Cl. CPC H01F 1/059; H01F 1/0558; H01F 1/0552

(57) ABSTRACT

A method for producing a phosphate-coated SmFeN-based anisotropic magnetic powder, the method includes a phosphate treatment of adding an inorganic acid to a slurry containing an SmFeN-based anisotropic magnetic powder, water, and a phosphate compound to adjust a pH of the slurry to a range of 1 to 4.5 to form a phosphate-coated SmFeN-based anisotropic magnetic powder having a surface coated with a phosphate.

### CROSS-REFERENCE TO RELATED APPLICATION

This application claims priority to Japanese Patent Application No. 2020-191743 filed on Nov. 18, 2020, Japanese Patent Application No. 2020-192544 filed on Nov. 19, 2020, and Japanese Patent Application No. 2020-201164 filed on Dec. 3, 2020, the disclosures of which are hereby incorporated by reference in their entireties.

### BACKGROUND

The present invention is related to a method for producing a phosphate-coated SmFeN-based anisotropic magnetic powder and to a phosphate-coated SmFeN-based anisotropic magnetic powder.

### BACKGROUND ART

SmFeN-based anisotropic magnetic powders are known to exhibit improved coercivity when the surface of the powder is coated with a phosphate. For example, Japanese Patent Publication No. 2020-056101 discloses a method for coating the surface of an SmFeN-based anisotropic magnetic powder with a phosphate by adding a phosphate treatment solution containing a pH-adjusted orthophosphoric acid to a slurry in which water containing an SmFeN-based anisotropic magnetic powder is used as a solvent.

Japanese Patent Publication No. 2017-210662 discloses a method of adding a pH-adjusted phosphate treatment solution to a slurry in which an organic solvent containing an SmFeN-based anisotropic magnetic powder having a large particle size is used as the solvent, and subsequently grinding the SmFeN-based anisotropic magnetic powder to thereby adjust the particle size of the SmFeN-based anisotropic magnetic powder and coat its surface with a phosphate.

Japanese Patent Publication No. 2014-160794 indicates that the coercivity of an SmFeN-based anisotropic magnetic powder coated with a phosphate is increased by subjecting the phosphate-coated SmFeN-based anisotropic magnetic powder to an oxidation treatment.

### SUMMARY

An object of the present invention is to provide a phosphate-coated SmFeN-based anisotropic magnetic powder having good coercivity and a method for producing the phosphate-coated SmFeN-based anisotropic magnetic powder.

### Solution to Problem

A method for producing a phosphate-coated SmFeN-based anisotropic magnetic powder according to one aspect of the present invention includes a phosphate treatment step of adding an inorganic acid to a slurry containing an SmFeN-based anisotropic magnetic powder, water, and a phosphate compound to adjust a pH of the slurry to a range from 1 to 4.5 to form an SmFeN-based anisotropic magnetic powder having a surface coated with a phosphate.

In addition, the phosphate-coated SmFeN-based anisotropic magnetic powder according to one aspect of the present invention has an exothermic onset temperature according to differential scanning calorimetry (DSC) of 170° C. or higher, and has a phosphate content of greater than 0.5 mass %.

According to the present invention, a phosphate-coated SmFeN-based anisotropic magnetic powder having good coercivity can be provided.

### BRIEF DESCRIPTION OF DRAWINGS

FIG. 1 is a cross-sectional SEM image of a magnetic powder of Example 2.

FIG. 2 is a cross-sectional SEM image of a magnetic powder of Comparative Example 1.

FIG. 3 is an SEM image of the magnetic powder of Example 2.

FIG. 4 is an SEM image of a magnetic powder of Comparative Example 3.

FIG. 5 is a graph of the particle size distributions of the magnetic powders of Example 2 and Comparative Example 3.

FIG. 6 is a table presenting STEM-EDX mapping analysis results of the magnetic powders of Example 2 and Comparative Example 1.

FIG. 7 is a graph of the results of EDX line profile analysis of the magnetic powder of Example 2.

FIG. 8 is a graph of the results of EDX line profile analysis of the magnetic powder of Comparative Example 1.

### DESCRIPTION OF EMBODIMENTS

Embodiments of the present invention will be described below. The following embodiments are examples for embodying the technical concept of the present invention, and are not intended to limit the present invention. Note that herein, the word “step” is included in the present terminology if the anticipated purpose of the step is achieved in the case of not only an independent step, but also a step that cannot be clearly distinguished from another step. Also, a numerical range indicated by “from x to y” indicates a range including the numerical values indicated by x and y as the minimum value and the maximum value, respectively.

### Method for Producing Phosphate-Coated SmFeN-Based Anisotropic Magnetic Powder

The method for producing a phosphate-coated SmFeN-based anisotropic magnetic powder according to the present embodiment is characterized by including a phosphate treatment step of adding an inorganic acid to a slurry containing an SmFeN-based anisotropic magnetic powder, water, and a phosphate compound to adjust the pH of the slurry to a range from 1 to 4.5 to thereby form an SmFeN-based anisotropic magnetic powder having a surface coated with a phosphate.

### Phosphate Treatment Step

In the phosphate treatment step, an inorganic acid is added to a slurry containing an SmFeN-based anisotropic magnetic powder, water, and a phosphate compound, and the pH of the slurry is adjusted to a range from 1 to 4.5 to thereby form an SmFeN-based anisotropic magnetic powder having a surface coated with a phosphate. The phosphate-coated SmFeN-based anisotropic magnetic powder is formed by reacting a metal component (for example, iron or samarium) contained in the SmFeN-based anisotropic magnetic powder and a phosphate component contained in the phosphate compound, and thereby depositing a phosphate (for example, iron phosphate or samarium phosphate) on the surface of the SmFeN-based anisotropic magnetic powder. When an inorganic acid is added and thus the pH is adjusted to a range from 1 to 4.5 according to the present embodiment, it is conceivable that the coercivity (iHc) is improved because, in comparison to a case in which an inorganic acid is not added, the deposition amount of the phosphate can be increased and thereby a phosphate-coated SmFeN-based anisotropic magnetic powder in which the thickness of the coating is thick can be formed. Furthermore, when water is used as the solvent according to the present embodiment, it is conceivable that the coercivity (iHc) is improved because, in comparison to a case in which the solvent is an organic solvent, a phosphate having a small particle size is deposited and thereby a phosphate-coated SmFeN-based anisotropic magnetic powder in which the coating is dense can be formed.

The method for producing a slurry containing an SmFeN-based anisotropic magnetic powder, water, and a phosphate compound is not particularly limited, but for example, the slurry can be obtained by mixing water as a solvent, the SmFeN-based anisotropic magnetic powder and an phosphate aqueous solution containing a phosphate compound. The content of the SmFeN-based anisotropic magnetic powder in the slurry is, for example, in a range from 1 mass % to 50 mass %, and from the perspective of productivity, the content thereof is preferably in a range from 5 mass % to 20 mass %. The content of the phosphate component (PO₄) in the slurry in terms of the amount of PO₄ is, for example, in a range from 0.01 mass % to 10 mass %, and from the perspectives of productivity and reactivity between the metal component and the phosphate component, the content thereof is preferably in a range from 0.05 mass % to 5 mass %.

The phosphate aqueous solution is formed by mixing a phosphate compound and water. Examples of the phosphate compound include phosphate-based compounds, such as orthophosphoric acid, sodium dihydrogen phosphate, sodium hydrogen phosphate, ammonium dihydrogen phosphate, ammonium hydrogen phosphate, zinc phosphate, and calcium phosphate, hypophosphorous acid-based compounds, hypophosphite-based compounds, pyrophosphate-based compounds, polyphosphate-based compounds, and other such inorganic phosphates, and organic phosphates. A single type of these phosphate compounds may be used alone, or a combination of two or more may be used. In addition, an oxoacid salt such as molybdate, tungstate, vanadate, and chromate, an oxidant such as sodium nitrate and sodium nitrite, and a chelating agent such as EDTA can be used as additives for the purpose of improving the water resistance and corrosion resistance of the coating and the magnetic properties of the magnetic powder.

The concentration (in terms of PO₄) of the phosphate in the phosphate aqueous solution is, for example, in a range from 5 mass % to 50 mass %, and from the perspectives of the solubility of the phosphate compound, storage stability, and ease of the chemical conversion treatment, the concentration thereof is preferably in a range from 10 mass % to 30 mass %. The pH of the phosphate aqueous solution is, for example, in a range from 1 to 4.5, and from the perspective of facilitating control of the deposition rate of the phosphate, the pH thereof is preferably in a range from 1.5 to 4. The pH can be adjusted using dilute hydrochloric acid, dilute sulfuric acid, or the like.

In the phosphate treatment step, an inorganic acid is added to adjust the pH of the slurry to a range from 1 to 4.5, preferably to a range from 1.6 to 3.9, and more preferably to a range from 2 to 3. If the pH is less than 1, coercivity tends to decrease because phosphate is deposited in a localized manner in large amounts, triggering aggregation of the phosphate-coated SmFeN-based anisotropic magnetic powder. If the pH exceeds 4.5, coercivity tends to decrease because the deposited amount of phosphate decreases and thereby the coating becomes insufficient. Examples of the inorganic acid added include hydrochloric acid, nitric acid, sulfuric acid, boric acid, and hydrofluoric acid. During the phosphate treatment step, the inorganic acid is added as needed such that the pH is within the range described above. An inorganic acid is used from the perspective of waste liquid treatment, but an organic acid can be used in combination according to the purpose. Examples of the organic acid include acetic acid, formic acid, and tartaric acid.

The phosphate treatment step may be implemented such that the lower limit of the phosphate content in the resulting phosphate-coated SmFeN-based anisotropic magnetic powder is greater than 0.5 mass %. The lower limit of the phosphate content of the resulting phosphate-coated SmFeN-based anisotropic magnetic powder in the phosphate treatment step is preferably 0.55 mass % or greater, and particularly preferably 0.75 mass % or greater, and the upper limit of the phosphate content is preferably 4.5 mass % or less, more preferably 2.5 mass % or less, and particularly preferably 2 mass % or less. When the phosphate content is not greater than 0.5 mass %, the effect of coating with the phosphate tends to be reduced, and when the phosphate content exceeds 4.5 mass %, the phosphate-coated SmFeN-based anisotropic magnetic powder tends to aggregate, and coercivity tends to decrease. Note that the phosphate content in the magnetic powder is expressed in terms of the amount of PO₄ molecules measured using inductively coupled plasma atomic emission spectroscopy (ICP-AES).

The phosphate treatment step is preferably implemented such that the phosphate coating present on the surface of the resulting SmFeN-based anisotropic magnetic powder has a region (high Sm concentration region) in which the Sm atomic concentration is higher than the Sm atomic concentration in the SmFeN-based anisotropic magnetic powder. The Sm atomic concentration in the high Sm concentration region can be, in relation to the Sm atomic concentration in the SmFeN-based anisotropic magnetic powder, 1.02 times or more, preferably 1.05 times or more, more preferably 1.1 times or more, and even more preferably 1.2 times or more. Furthermore, the Sm atomic concentration in the high Sm concentration region is, for example, preferably not more than 3 times the Sm atomic concentration in the SmFeN-based anisotropic magnetic powder. Here, the high Sm concentration region is a region including a layer exhibiting a maximum peak of phosphorus (P) in a STEM-EDX line profile analysis of the phosphate-coated SmFeN-based anisotropic magnetic powder. The thickness of the high Sm concentration region can be, for example, 5 nm or greater, and is preferably in a range from 10 nm to 200 nm. The atomic concentration (atm %) of each element in the high Sm concentration region is determined by averaging the atomic concentration (atm %) in the phosphate coating from STEM-EDX line profile analysis.

Adjusting a pH of the slurry containing an SmFeN-based anisotropic magnetic powder, water, and a phosphate compound to be in a range from 1 to 4.5 is performed preferably over a period of 10 minutes or longer, and more preferably over a period of 30 minutes or longer from the perspective of reducing portions of the coating at which the thickness is thin. At the initial stage of pH maintenance, the pH rises rapidly, and therefore the interval between each introduction of the inorganic acid for pH control is short. However, as the coating progresses, changes in pH gradually slow down, and the interval between each introduction of the inorganic acid becomes longer, and therefore the reaction end point can be determined.

Oxidation Step after Phosphate Treatment

The phosphate-coated SmFeN-based anisotropic magnetic powder may be subjected to an oxidation treatment as necessary. By oxidizing the phosphate-coated SmFeN-based anisotropic magnetic powder, the surface of the SmFeN-based anisotropic magnetic powder, which is the base coated with the phosphate, is oxidized, and an iron oxide layer is formed, and thereby the oxidation resistance of the phosphate-coated SmFeN-based anisotropic magnetic powder is improved. Also, by subjecting to oxidation, the occurrence of an oxidation-reduction reaction, a decomposition reaction, and modification, which are not preferable, on the surface of the SmFeN particle when the phosphate-coated SmFeN-based anisotropic magnetic powder is exposed to high temperatures during production of a bonded magnet can be suppressed, and as a result, a magnet having high magnetic properties and, in particular, high intrinsic coercivity (iHc), can be formed.

The oxidation treatment is carried out by heat treating the SmFeN-based anisotropic magnetic powder in an oxygen-containing atmosphere after the phosphate treatment. The reaction atmosphere preferably contains oxygen in an inert gas such as nitrogen or argon. The oxygen concentration is preferably in a range from 3% to 21%, and more preferably in a range from 3.5% to 10%. During the oxidation reaction, gas is preferably exchanged at a flow rate in a range from 2 L/min to 10 L/min in relation to 1 kg of the magnetic powder.

The temperature during the oxidation treatment is preferably in a range from 150° C. to 250° C., and is more preferably in a range from 170° C. to 230° C. At a temperature of less than 150° C., production of the iron oxide layer is insufficient, and the oxidation resistance tends to decrease. When the temperature exceeds 250° C., the iron oxide layer is formed in excess, and the coercivity tends to decrease. The reaction time is preferably in a range from 3 hours to 10 hours.

### Phosphate-Coated SmFeN-Based Anisotropic Magnetic Powder

The phosphate-coated SmFeN-based anisotropic magnetic powder according to the present embodiment is characterized by having an exothermic onset temperature according to DSC of 170° C. or higher, and having a phosphate content of greater than 0.5 mass %.

The exothermic onset temperature of the phosphate-coated SmFeN-based anisotropic magnetic powder according to DSC is 170° C. or higher, and is more preferably 200° C. or higher. The exothermic onset temperature according to DSC is a comprehensive evaluation of properties such as the density, thickness, and oxidation resistance of the phosphate coating, and the phosphate-coated SmFeN-based anisotropic magnetic powder with high coercivity is obtained when the exothermic onset temperature is 170° C. or higher. Note that the exothermic onset temperature according to DSC can be measured under the conditions described in the examples. Also note that the phosphate content in the phosphate-coated SmFeN-based anisotropic magnetic powder is as indicated in the phosphate treatment step.

The phosphate-coated SmFeN-based anisotropic magnetic powder is preferably such that, in an XRD diffraction pattern, a ratio (I)/(II) of a diffraction peak intensity (I) of a (110) plane of αFe to a peak intensity (II) of a (300) plane of the SmFeN-based magnetic powder is 2.0×10⁻² or less, and more preferably 1.0×10⁻² or less. The diffraction peak intensity (I) of the αFe (110) plane represents the presence amount of the impurity αFe, and when the ratio (I)/(II) described above is 2.0×10⁻² or less, the phosphate-coated SmFeN-based anisotropic magnetic powder with high coercivity is obtained. Note that the diffraction peak intensity in the XRD diffraction pattern can be measured under the conditions described in the examples.

The carbon content of the phosphate-coated SmFeN-based anisotropic magnetic powder is preferably 1000 ppm or less, and more preferably 800 ppm or less. The carbon content indicates the amount of organic impurities in the phosphate, and when the carbon content exceeds 1000 ppm, organic impurities decompose and thus produce defects in the coating when the phosphate-coated SmFeN-based anisotropic magnetic powder is exposed to high temperatures in the process of producing a bonded magnet, and as a result, coercivity tends to decrease. Here, the carbon content can be measured by the TOC method.

From the perspective of the coercivity of the phosphate-coated SmFeN-based anisotropic magnetic powder, the thickness of the phosphate coating of the phosphate-coated SmFeN-based anisotropic magnetic powder is preferably in a range from 10 nm to 200 nm. Note that the thickness of the phosphate coating can be measured by carrying out a composition analysis through line profile analysis by EDX in a cross section of the phosphate-coated SmFeN-based anisotropic magnetic powder.

The phosphate coating present on the surface of the SmFeN-based anisotropic magnetic powder preferably has a region (high Sm concentration region) in which the Sm atomic concentration is higher than the Sm atomic concentration in the SmFeN-based anisotropic magnetic powder. The Sm atomic concentration in the high Sm concentration region can be, in relation to the Sm atomic concentration in the SmFeN-based anisotropic magnetic powder, 1.02 times or more, preferably 1.05 times or more, more preferably 1.1 times or more, and even more preferably 1.2 times or more. In addition, the Sm atomic concentration in the high Sm concentration region can be, for example, not more than three times the Sm atomic concentration in the SmFeN-based anisotropic magnetic powder. Here, the high Sm concentration region is a region including a layer exhibiting a maximum peak of phosphorus (P) in a STEM-EDX line profile analysis of the phosphate-coated SmFeN-based anisotropic magnetic powder. The thickness of the high Sm concentration region can be, for example, 5 nm or greater, and is preferably in a range from 10 nm to 200 nm, and more preferably in a range from 10 nm to 100 nm. The atomic concentration (atm %) of each element in the high Sm concentration region is determined by averaging the atomic concentration (atm %) in the phosphate coating from STEM-EDX line profile analysis.

The Sm atomic concentration in the high Sm concentration region is more preferably not less than 0.5 times the Fe atomic concentration in the high Sm concentration region, and even more preferably not less than 1 times the Fe atomic concentration thereof. The Sm atomic concentration in the high Sm concentration region is preferably not more than 4 times the Fe atomic concentration in the high Sm concentration region. The Sm atomic concentration in the high Sm concentration region is preferably higher than the Fe atomic concentration. When the relationship between the Sm atomic concentration and the Fe atomic concentration in the high Sm concentration region is within the range described above, the Fe atomic concentration in the vicinity of the surface of the SmFeN-based anisotropic magnetic powder becomes low, and water resistance tends to further improve.

When molybdate is blended in the reaction slurry in the phosphate treatment step, the phosphate coating may include Mo. The Mo in the phosphate coating preferably increases gradually from the outermost surface of the SmFeN-based anisotropic magnetic powder to the surface of the phosphate coating. The Mo atomic concentration at the surface of the phosphate coating is preferably not less than 1.2 times and more preferably not less than 1.5 times the Mo atomic concentration of the outermost surface of the SmFeN-based anisotropic magnetic powder. When the Mo atomic concentration at the surface of the phosphate coating and the Mo atomic concentration at the outermost surface of the SmFeN-based anisotropic magnetic powder are in a relationship of the range described above, the Mo atomic concentration increases closer to the surface side of the phosphate coating, and this may contribute to enhanced corrosion resistance.

Furthermore, the Fe atomic concentration in the phosphate coating is preferably lower than the Fe atomic concentration in the SmFeN-based anisotropic magnetic powder, which is the base. The Fe atomic concentration in the phosphate coating is more preferably not more than 0.3 times and even more preferably not more than 0.1 times the Fe atomic concentration in the SmFeN-based anisotropic magnetic powder, which is the base. In addition, the Fe atomic concentration in the phosphate coating can be, for example, not less than 0.05 times the Fe atomic concentration in the SmFeN-based anisotropic magnetic powder, which is the base.

### Silica Treatment Step

After the phosphate treatment, the SmFeN-based anisotropic magnetic powder may be subjected to a silica treatment as necessary. Oxidation resistance can be improved by forming a silica thin film on the magnetic powder. The silica thin film can be formed, for example, by mixing an alkyl silicate, the phosphate-coated SmFeN-based anisotropic magnetic powder, and an alkaline solution.

### Silane Coupling Treatment Step

The magnetic powder after the silica treatment may be further treated with a silane coupling agent. A coupling agent film is formed on the silica thin film by subjecting the magnetic powder on which the silica thin film is formed to a silane coupling treatment, and thereby the magnetic properties of the magnetic powder are improved, and wettability with a resin and the strength of the magnet can be improved. The silane coupling agent is not particularly limited as long as it is selected in accordance with the type of resin, and examples of the silane coupling agent include 3-aminopropyl triethoxysilane, γ-(2-aminoethyl) aminopropyl trimethoxysilane, γ-(2-aminoethyl) aminopropylmethyl dimethoxysilane, γ-methacryloxypropyl trimethoxysilane, γ-methacryloxypropyl dimethoxysilane, N—O—(N-vinylbenzylaminoethyl)-γ-aminopropyl trimethoxysilane hydrochloride, γ-glycidoxypropyl trimethoxysilane, γ-mercaptopropyl trimethoxysilane, methyl trimethoxysilane, methyl triethoxysilane, vinyl triacetoxysilane, γ-chloropropyl trimethoxysilane, hexamethylene disilazane, γ-anilinopropyl trimethoxysilane, vinyl trimethoxysilane, octadecyl[3-(trimethoxysilyl)propyl]ammonium chloride, γ-chloropropylmethyl dimethoxysilane, γ-mercaptopropylmethyl dimethoxysilane, methyl trichlorosilane, dimethyl dichlorosilane, trimethylchlorosilane, vinyl trichlorosilane, vinyl tris(β-methoxyethoxy)silane, vinyl triethoxysilane, β-(3,4-epoxycyclohexyl)ethyl trimethoxysilane, γ-glycidoxypropylmethyl diethoxysilane, N-β(aminoethyl)γ-aminopropyl trimethoxysilane, N-β(aminoethyl)γ-aminopropylmethyl dimethoxysilane, γ-aminopropyl triethoxysilane, N-phenyl-γ-aminopropyl trimethoxysilane, oleidopropyl triethoxysilane, γ-isocyanatopropyl triethoxysilane, polyethoxydimethylsiloxane, polyethoxymethylsiloxane, bis(trimethoxysilylpropyl)amine, bis(3-triethoxysilylpropyl)tetrasulfane, γ-isocyanatopropyl trimethoxysilane, vinylmethyl dimethoxysilane, 1,3,5-N-tris(3-trimethoxysilylpropyl)isocyanurate, t-butylcarbamate trialkoxysilane, N-(1,3-dimethylbutylidene)-3-(triethoxysilyl)-1-propanamine. A single type of these silane coupling agents may be used alone, or two or more may be combined and used. The addition amount of the silane coupling agent is preferably in a range from 0.2 parts by weight to 0.8 parts by weight, and more preferably in a range from 0.25 parts by weight to 0.6 parts by weight, per 100 parts by weight of the magnetic powder. When the addition amount of the silane coupling agent is less than 0.2 parts by weight, the effect of the silane coupling agent is small, and when the addition amount exceeds 0.8 parts by weight, the magnetic properties of the magnetic powder and magnet tend to be reduced due to aggregation of the magnetic powder.

After the phosphate treatment step, after the oxidation step, and after the silica treatment or silane coupling treatment, the SmFeN-based anisotropic magnetic powder can be filtered, dehydrated, and dried by normal methods.

### SmFeN-Based Anisotropic Magnetic Powder>

The SmFeN-based anisotropic magnetic powder used in the phosphate treatment step is not particularly limited, but, for example, an SmFeN-based anisotropic magnetic powder produced by the following method can be favorably used. Namely, the SmFeN-based anisotropic magnetic powder may be produced by a method including a step (precipitation step) of forming a precipitate containing Sm and Fe by mixing a solution containing Sm and Fe and a precipitant to, a step (oxidation step) of forming an oxide containing Sm and Fe by firing the precipitate, a step (pretreatment step) of forming a partial oxide by heat treating the oxide in an environment containing a reducing gas, a step (reduction step) of reducing the partial oxide, and a step (nitriding step) of subjecting alloy particles formed in the reduction step to a nitriding treatment.

### Precipitation Step

In the precipitation step, a solution containing Sm and Fe is prepared by dissolving an Sm raw material and an Fe raw material in a strongly acidic solution. When Sm₂Fe₁₇N₃ is formed as the main phase, the molar ratio of Sm and Fe (Sm:Fe) is preferably in a range from 1.5:17 to 3.0:17, and more preferably in a range from 2.0:17 to 2.5:17. Raw materials such as La, W, Co, Ti, Sc, Y, Pr, Nd, Pm, Gd, Tb, Dy, Ho, Er, Tm, and Lu may be added to the above-mentioned solution.

The Sm raw material and the Fe raw material are not limited as long as they can be dissolved in the strongly acidic solution. In terms of ease of availability, an example of the Sm raw material includes samarium oxide, and an example of the Fe raw material includes FeSO₄. The concentration of the solution containing Sm and Fe can be adjusted, as appropriate, in a range in which the Sm raw material and the Fe raw material are substantially dissolved in the acidic solution. From the perspective of solubility, an example of the acidic solution includes sulfuric acid.

An insoluble precipitate containing Sm and Fe is formed by reacting the solution containing Sm and Fe with a precipitant. Here, the solution containing Sm and Fe need only be a solution containing Sm and Fe when reacted with the precipitant, and, for example, raw materials containing Sm and Fe may be prepared as separate solutions, and each solution may be added dropwise to react with the precipitant. Even when prepared as separate solutions, appropriate adjustment is performed in a range in which each raw materials is substantially dissolved in the acidic solution. The precipitant is not limited as long as it is an alkaline solution that reacts with the solution containing Sm and Fe to produce a precipitate. Examples of the precipitant include ammonia water and caustic soda, and caustic soda is preferable.

As the precipitation reaction, a method in which the precipitant and the solution containing Sm and Fe are each added dropwise to a solvent such as water is preferable because adjustment can be easily performed according to the properties of the precipitate particles. Details such as the supply rates of the precipitant and the solution containing Sm and Fe, the reaction temperature, the reaction solution concentration, and the pH during the reaction are appropriately controlled, and thereby a precipitate having a uniform distribution of constituent elements, a sharp particle size distribution, and a regulated powder shape is formed. The magnetic properties of the magnetic powder that is the final product are improved by using such a precipitate. The reaction temperature can be set in a range from 0° C. to 50° C., and is preferably in a range from 35° C. to 45° C. As a total concentration of metal ions, the reaction solution concentration is preferably in a range from 0.65 mol/L to 0.85 mol/L, and more preferably in a range from 0.7 mol/L to 0.84 mol/L. The reaction pH is preferably in a range from 5 to 9, and more preferably in a range from 6.5 to 8.

The powder particle size, powder shape, and particle size distribution of the magnetic powder that is ultimately formed is generally determined by the anisotropic magnetic powder particles formed in the precipitation step. The powder is preferably of a size and distribution such that when the particle size of the formed particles is measured using a laser diffraction-type wet particle size distribution meter, the particle size of all of the powder is substantially within a range from 0.05 pin to 20 pin, and preferably within a range from 0.1 pin to 10 pin. Additionally, the average particle size of the anisotropic magnetic powder particles is measured as a particle size corresponding to a cumulative volume of 50% from the small particle size side in the particle size distribution, and is preferably within a range from 0.1 pin to 10 pin.

After the precipitate is separated, the solvent is preferably removed from the separated product, in order to suppress aggregation of the precipitate and changes in the particle size distribution, the particle size of the powder, or the like when the precipitate is redissolved in the remaining solvent and the solvent evaporates in the heat treatment of the subsequent oxidation step. When, for example, water is used as the solvent, a specific example of the method for removing the solvent includes drying in an oven at a temperature in a range from 70° C. to 200° C. for a time in a range from 5 hours to 12 hours.

After the precipitation step, steps of separating and washing the resulting precipitate may be included. The washing step is appropriately carried out until the conductivity of the supernatant solution becomes 5 mS/m² or less. As the step of separating the precipitate, for example, a filtration method, a decantation method, or the like can be used after a solvent (preferably water) is added to the formed precipitate and mixed.

### Oxidation Step

The oxidation step is a step of forming an oxide containing Sm and Fe by firing the precipitate formed in the precipitation step. For example, the precipitate can be converted to an oxide by heat treatment. When the precipitate is heat treated, the heat treatment must be implemented in the presence of oxygen, and for example, the heat treatment can be carried out in an air atmosphere. Also, because the heat treatment must be carried out in the presence of oxygen, oxygen atoms are preferably included in a non-metal portion in the precipitate.

The heat treatment temperature (hereinafter, the oxidation temperature) in the oxidation step is not particularly limited, but is preferably in a range from 700° C. to 1300° C., and more preferably in a range from 900° C. to 1200° C. At a temperature of less than 700° C., the oxidation is insufficient, and when the temperature exceeds 1300° C., the targeted shape, average particle size, and particle size distribution of the magnetic powder tend not to be obtained. The heat treatment time is also not particularly limited, but is preferably in a range from 1 hour to 3 hours.

The formed oxide is an oxide particle in which Sm and Fe are sufficiently mixed microscopically, and the shape of the precipitate, the particle size distribution, and the like are reflected.

### Pretreatment Step

The pretreatment step is a step of forming a partial oxide, in which a portion of the oxide is reduced, by heat treating an oxide containing Sm and Fe in a reducing gas atmosphere.

Here, the partial oxide refers to an oxide in which a portion of the oxide is reduced. The oxygen concentration in the oxide is not particularly limited, but is preferably 10 mass % or less, and more preferably 8 mass % or less. When the concentration exceeds 10 mass %, the generation of heat in reduction with Ca becomes large in the reduction step, and the firing temperature increases, and thereby particles with abnormal particle growth tend to be formed. Here, the oxygen concentration of the partial oxide can be measured by a non-dispersive infrared absorption method (ND-IR).

The reducing gas is selected, as appropriate, from hydrogen (H₂), carbon monoxide (CO), hydrocarbon gases such as methane (CH₄), and the like, but in terms of cost, hydrogen gas is preferable. The flow rate of the gas is adjusted, as appropriate, within a range in which the oxide does not scatter. The heat treatment temperature (hereinafter, pretreatment temperature) in the pretreatment step is in a range from 300° C. to 950° C., preferably 400° C. or higher, and more preferably 750° C. or higher, and also preferably lower than 900° C. When the pretreatment temperature is 300° C. or higher, the reduction of the oxide containing Sm and Fe proceeds efficiently. When the pretreatment temperature is 950° C. or lower, particle growth and segregation of the oxide particles can be suppressed, and the desired particle size can be maintained. Additionally, when hydrogen is used as the reducing gas, preferably, the thickness of the oxide layer used is adjusted to 20 mm or less, and the dew point in the reaction furnace is adjusted to −10° C. or lower.

### Reduction Step

The reduction step is a step of forming alloy particles by heat treating the partial oxide in the presence of a reducing agent at a temperature in a range from 920° C. to 1200° C., and for example, reduction is carried out by causing the partial oxide to contact a calcium melt or calcium vapor. From the perspective of magnetic properties, the heat treatment temperature is preferably in a range from 950° C. to 1150° C., and more preferably in a range from 980° C. to 1100° C. From the perspective of more uniformly carrying out the reduction reaction, the heat treatment time is preferably less than 120 minutes, and more preferably less than 90 minutes, and the heat treatment time is preferably 10 minutes or longer, and more preferably 30 minutes or longer as the lower limit thereof.

Metal calcium is used in a granular or powdered form, and the particle size of the metal calcium is preferably 10 mm or less. This can suppress aggregation during the reduction reaction more effectively. Furthermore, the metal calcium can be added at a ratio in a range from 1.1 times to 3.0 times the reaction equivalent (the stoichiometric amount required to reduce the Sm oxide, and when Fe is in the form of an oxide, the reaction equivalent includes the amount necessary to reduce the Fe oxide), and is preferably added at a ratio in a range from 1.5 times to 2.0 times the reaction equivalent.

In the reduction step, a disintegration accelerator can be used as necessary along with metal calcium, which is a reducing agent. The disintegration accelerator is used, as appropriate, to promote disintegration and granulation of products during a rinsing step described below, and examples of the disintegration accelerator include alkaline earth metal salts such as calcium chloride, and alkaline earth oxides such as calcium oxide. These disintegration accelerators are used at a proportion in a range from 1 mass % to 30 mass %, and preferably in a range from 5 mass % to 28 mass %, per the Sm oxide used as the Sm source.

### Nitriding Step

The nitriding step is a step of forming anisotropic magnetic particles by nitriding the alloy particles formed in the reduction step. Because the particulate precipitate formed in the aforementioned precipitation step is used, porous clump-shaped alloy particles are formed in the reduction step. As a result, these particles can be heat treated and nitrided immediately in a nitrogen atmosphere without being subjected to grinding, and thus nitriding can be uniformly implemented.

The heat treatment temperature (hereinafter, the nitriding temperature) in the nitriding treatment of the alloy particles is preferably in a range from 300° C. to 600° C., and particularly preferably in a range from 400° C. to 550° C., and the nitriding treatment is carried out by replacing the atmospheric air with a nitrogen atmosphere in this temperature range. The heat treatment time need only be set to a time that allows the alloy particles to be sufficiently and uniformly nitrided.

The product formed after the nitriding step includes, in addition to the magnetic particles, a byproduct of CaO, unreacted metal calcium, and the like, and these products may be combined in a sintered mass state. Thus, in this case, the product can be put into cooling water to separate the CaO and metal calcium as a calcium hydroxide (Ca(OH)₂) suspension from the magnetic particles. Furthermore, the remaining calcium hydroxide may be sufficiently removed by washing the magnetic particles with acetic acid or the like.

The SmFeN-based anisotropic magnetic powder formed by the above-described production method has a Th₂Zn₁₇ type crystal structure and is a nitride that is represented by the general formula SmₓFe_{100-x-y}N_{y} and contains the rare earth metal samarium (Sm), iron (Fe), and nitrogen (N). Here, preferably, x is in a range from 8.1 atom % to 10 atom %, y is in a range from 13.5 atom % to 13.9 atom %, and the balance is mainly Fe.

The average particle size of the SmFeN-based anisotropic magnetic powder is preferably in a range from 2 μm to 5 μm, and more preferably in a range from 2.5 μm to 4.8 μm. When the average particle size is less than 2 μm, the filling amount of magnetic powder in the bonded magnet decreases, and thus magnetization is reduced, and when the average particle size exceeds 5 μm, the coercivity of the bonded magnet tends to decrease. Here, the average particle size is a particle size measured in dry conditions using a laser diffraction-type particle size distribution measurement device.

The particle size D10 of the SmFeN-based anisotropic magnetic powder is preferably in a range from 1 μm to 3 μm, and more preferably in a range from 1.5 μm to 2.5 μm. When particle size D10 is less than 1 μm, the filling amount of the magnetic powder in the bonded magnet decreases, and thus magnetization is reduced, and when the particle size D10 exceeds 3 μm, the coercivity of the bonded magnet tends to decrease. Here, D10 is a particle size at which the integrated value of the volume-based particle size distribution of the SmFeN-based anisotropic magnetic powder is equivalent to 10%.

The particle size D50 of the SmFeN-based anisotropic magnetic powder is preferably in a range from 2.5 μm to 5 μm, and is more preferably in a range from 2.7 μm to 4.8 μm. When the particle size D50 is less than 2.5 μm, the filling amount of magnetic powder in the bonded magnet decreases, and thus magnetization is reduced, and when the particle size D50 exceeds 5 μm, the coercivity of the bonded magnet tends to decrease. Here, D50 is a particle size at which the integrated value of the volume-based particle size distribution of the SmFeN-based anisotropic magnetic powder is equivalent to 50%.

The particle size D90 of the SmFeN-based anisotropic magnetic powder is preferably in a range from 3 μm to 7 μm, and more preferably in a range from 4 μm to 6 μm. When the particle size D90 is less than 3 μm, the filling amount of magnetic powder in the bonded magnet decreases, and thus magnetization is reduced, and when the particle size D90 exceeds 7 μm, the coercivity of the bonded magnet tends to decrease. Here, D90 is a particle size at which the integrated value of the volume-based particle size distribution of the SmFeN-based anisotropic magnetic powder is equivalent to 90%.

A span defined as span=(D90−D10)/D50 for the SmFeN-based anisotropic magnetic powder is preferably 2 or less, and more preferably 1.5 or less from the perspective of coercivity. The particle size distribution of the magnetic powder used in the bonded magnet compound is preferably a mono-dispersion from the perspective of the rectangularity of the demagnetization characteristics.

The circularity of the SmFeN-based anisotropic magnetic powder is not particularly limited, but is preferably 0.5 or higher, and more preferably 0.6 or higher. When the circularity is less than 0.5, fluidity worsens, and thereby stress is applied between particles during molding, and thus the magnetic properties are reduced. Here, to measure circularity, an SEM image captured at 3000× is binarized through image processing, and the circularity of one particle is determined. The circularity specified in the present invention refers to an average value of circularity determined by measuring particles of an approximate quantity in a range from 1000 to 10000. In general, the circularity increases as the number of particles having a small particle size increases, and therefore the circularity is measured for particles having a particle size of 1 μm or greater. In the measurement of circularity, a defined equation of circularity=(4πS/L2) is used. Here, S is the two-dimensional projected area of the particle, and L is the two-dimensional projected circumferential length.

The phosphate-coated SmFeN-based anisotropic magnetic powder of the present embodiment can be used primarily as a bonded magnet.

A bonded magnet compound is formed from the magnetic powder of the present embodiment and a resin. By including this magnetic powder, a bonded magnet compound having high magnetic properties can be configured.

The resin contained in the bonded magnet compound may be a thermosetting resin or a thermoplastic resin, but is preferably a thermoplastic resin. Specific examples of the thermoplastic resin include polyphenylene sulfide (PPS), polyether ether ketone (PEEK), liquid crystal polymer (LCP), polyamide (PA), polypropylene (PP), and polyethylene (PE).

The weight ratio (resin/magnetic powder) of the resin to the magnetic powder when the bonded magnet compound is formed is preferably in a range from 0.08 to 0.15, and more preferably in a range from 0.09 to 0.13.

The bonded magnet compound can be formed, for example, by mixing the magnetic powder and the resin at a temperature in a range from 180° C. to 300° C. using a kneader. For example, after the magnetic powder and the resin powder are mixed in a mixer, a strand is extruded by a twin-screw extruder, air cooled, and then cut to a size of several mm by a pelletizer, and thereby a bonded magnet compound in the shape of pellets can be formed.

A bonded magnet can be manufactured by using the bonded magnet compound and an appropriate molding machine. Specifically, for example, a bonded magnet can be formed by melting the bonded magnet compound in a molding machine barrel, injection molding the molten bonded magnet compound into a mold to which a magnetic field is applied, aligning the easily-magnetized axes (orientation step), cooling and solidifying the material, and subsequently magnetizing with an air-core coil or a magnetizing yoke (magnetization step).

The barrel temperature is selected according to the type of resin to be used, and can be set to a range from 160° C. to 320° C., and similarly, the mold temperature can be set, for example to a range from 30° C. to 150° C. An oriented magnetic field in the orientation step is generated using an electromagnet or a permanent magnet, and the magnitude of the magnetic field is preferably 4 kOe or greater, and more preferably 6 kOe or greater. Furthermore, the magnitude of the magnetic field in the magnetization step is preferably 20 kOe or greater, and more preferably 30 kOe or greater.

The method for producing a first bonded magnet compound according to the present embodiment is characterized by including:
forming a bonded magnet additive by heat curing a thermosetting resin and a curing agent, the curing agent having a ratio of a number of reactive groups to a number of reactive groups of the thermosetting resin in a range from 2 to 11; and
kneading the bonded magnet additive, a magnetic powder formed by the above-described method for producing the phosphate-coated SmFeN-based anisotropic magnetic powder or the above-described magnetic powder, and a thermoplastic resin, to form a bonded magnet compound having a filling ratio of magnetic powder in the bonded magnet compound of 91.5 mass % or higher.

In producing a bonded magnet containing a thermoplastic resin, when the mixture formed by kneading the thermoplastic resin and the thermosetting resin is injection-molded, the reactive groups of the thermosetting resin (for example, glycidyl groups in the case of an epoxy resin) and the reactive groups of the thermoplastic resin (for example, amide groups in the case of nylon 12) react, and thus, the fluidity of the resins may decrease, resulting in poor moldability. In the present embodiment, a cured product of the thermosetting resin and a curing agent can be used as an additive in a bonded magnet containing a thermoplastic resin when a ratio of the equivalent weight of the curing agent to the equivalent weight of the thermosetting resin is in a range from 2 to 11, because the reactive groups of the thermosetting resin are sufficiently deactivated by the reactive groups of the curing agent (for example, amino groups in the case of diaminodiphenyl sulfone (DDS)), and therefore a reaction with the reactive groups of the thermoplastic resin does not easily occur, and a decrease in fluidity of the resins can be suppressed. In addition, when a bonded magnet is to be produced by injection molding using a bonded magnet compound produced from a bonded magnet additive containing a thermoplastic resin according to the present embodiment, the injection pressure can be lowered, and thus the magnetic properties of the formed bonded magnet are improved.

The thermosetting resin is not particularly limited as long as the thermosetting resin can be heat cured, and examples include epoxy resins, phenol resins, urea resins, melamine resins, guanamine resins, unsaturated polyester resins, vinyl ester resins, diallyl phthalate resins, polyurethane resins, silicone resins, polyimide resins, alkyd resins, furan resins, dicyclopentadiene resins, acrylic resins, and allyl carbonate resins. Among these, epoxy resins are preferable from the perspectives of mechanical properties and heat resistance. The thermosetting resin is preferably a liquid at room temperature or a solid that dissolves in a solvent and becomes a liquid.

The curing agent is not particularly limited as long as the curing agent heat cures the selected thermosetting resin, and when the thermosetting resin is an epoxy resin, examples of the curing agent include an amine-based curing agent, an acid anhydride-based curing agent, a polyamide-based curing agent, an imidazole-based curing agent, a phenol resin-based curing agent, a polymercaptan resin-based curing agent, a polysulfide resin-based curing agent, and an organic acid hydrazide-based curing agent. Examples of the amine-based curing agent include diamino diphenyl sulfone, meta-phenylene diamine, diamino diphenylmethane, diethylene triamine, and triethylene tetramine.

The blending amount of the curing agent is adjusted at a ratio of the number of reactive groups of the curing agent to the number of reactive groups of the thermosetting resin (the ratio of the equivalent weight of the curing agent to the equivalent weight of the thermosetting resin). The ratio of number of reactive groups of the curing agent to the number of reactive groups of the thermosetting resin is in a range from 2 to 11, is preferably in a range from 2 to 10, and is more preferably in a range from 2 to 7. Furthermore, the lower limit of the number of reactive groups is preferably greater than 2.5, and is more preferably 3 or greater. When the ratio exceeds 11, the mechanical properties of the bonded magnet are reduced, and when the ratio is less than 2, the ratio of the number of reactive groups of the curing agent to the number of reactive groups of the thermosetting resin is small, and thus the reactive groups of the thermosetting resin remain. When the material is kneaded with a thermoplastic resin in a subsequent step, the reactive groups of the thermoplastic resin and the residual reactive groups of the thermosetting resin react, and thereby the viscosity increases during injection molding, and the moldability of the bonded magnet and the mechanical properties of the molded article formed are worse than the moldability and mechanical properties of the thermoplastic resin alone. Here, the equivalent weight of the thermosetting resin refers to the number of grams of resin containing 1 gram equivalent weight of the reactive groups, and the equivalent weight of the curing agent refers to the equivalent weight of active hydrogen.

The cured product can be formed by blending a curing agent into the thermosetting resin described above and heat curing. The temperature for heat curing can be set in accordance with the characteristics of the thermosetting resin used, and from the perspective of curability, the heat curing temperature is preferably in a range from 60° C. to 250° C., and more preferably in a range from 180° C. to 220° C.

The cured product can be ground as necessary. The method for grinding the cured product is not particularly limited, and a sample mill, a ball mill, a stamp mill, a mortar, mixer grinding, and the like can be used. If necessary, the ground product can be sorted using a sieve or the like. From the perspective of compatibility with the thermoplastic resin, the average particle size of the ground product is preferably 1000 μm or less, and more preferably 500 μm or less.

The bonded magnet additive can also be formed by blending a curing accelerator together with the thermosetting resin and the curing agent, and curing the mixture. Examples of the curing accelerator include 1,8-diazabicyclo (5,4,0)-undecene-7, 1,5 diazabicyclo (4,3,0)-nonene-5, 1-cyanoethyl-2-ethyl-4-methylimidazole, 2-methyl-4-methylimidazole, triphenylphosphine, and sulfonium salt. The content of the curing accelerator is not particularly limited, but the curing accelerator is generally added at an amount in a range from 0.01 mass % to 10 mass % in relation to the total amount of the thermosetting resin and curing agent.

In the kneading step, the bonded magnet additive, the magnetic powder, and the thermoplastic resin are melt kneaded to produce a bonded magnet compound to be used in injection molding. The melt kneader is not particularly limited, but a single screw kneader, a twin-screw kneader, a mixing roll, a kneader, a Banbury mixer, an intermeshing twin-screw extruder, a non-intermeshing twin-screw extruder, or the like can be used. The melt kneading temperature is not particularly limited and can be set according to the properties of the thermoplastic resin to be used, but is preferably in a range from 180° C. to 250° C.

The thermoplastic resin is not particularly limited as long as it is a resin that can be injection molded, and examples include nylon resins (polyamides); polyolefins such as polypropylene (PP) and polyethylene (PE); polyesters; polycarbonates (PC); polyphenylene sulfide (PPS); polyether ether ketone (PEEK); polyacetal (POM); and liquid crystal polymers (LCP). Examples of the nylon resins include polylactams, such as 6 nylon, 11 nylon, 12 nylon; condensates of dicarboxylic acid and a diamine, such as 6,6 nylon, 6,10 nylon, and 6,12 nylon; copolymerized polyamides, such as 6 nylon/6,6 nylon, 6 nylon/6,10 nylon, 6 nylon/12 nylon, 6 nylon/6,12 nylon, 6 nylon/6,10 nylon/6,10 nylon, 6 nylon/6,6 nylon/6,12 nylon, and 6 nylon/polyether; and nylon 6T, nylon 9T, nylon MXD6, aromatic nylon, and amorphous nylon. Among these thermoplastic resins, a nylon resin is preferable because of the good balance between low water absorption, moldability, and mechanical properties, and 12 nylon is particularly preferable.

In the method for producing the first bonded magnet compound according to the present embodiment, the filling ratio of the magnetic powder in the bonded magnet compound is 91.5 mass % or higher, preferably 91.8 mass % or higher, and more preferably 92.2 mass % or higher. The upper limit is not particularly limited, but is preferably 93.2 mass % or less, more preferably 92.8 mass % or less, and even more preferably 92.5 mass % or less. When the filling ratio exceeds 93.2 mass %, the viscosity during injection molding increases and results in a decrease in moldability.

The content of the bonded magnet additive in the first bonded magnet compound of the present embodiment is preferably in a range from 0.5 mass % to 4.2 mass %, more preferably in a range from 0.9 mass % to 3.5 mass %, and even more preferably in a range from 0.9 mass % to 1.2 mass %. When the content of the bonded magnet additive exceeds 4.2 mass %, the residual magnetic flux density of the bonded magnet decreases, and when the content thereof is less than 0.5 mass %, the viscosity during injection molding increases and may result in a decrease in moldability.

The content of the thermoplastic resin in the first bonded magnet compound of the present embodiment is preferably 8.0 mass % or less, and is more preferably 6.5 mass % or less. The lower limit is not particularly limited, but is preferably 4.2 mass % or higher, and more preferably 5.5 mass % or higher. When the addition amount of the thermoplastic resin exceeds 8.0 mass %, the residual magnetic flux density of the bonded magnet decreases, and when the addition amount is less than 4.2 mass %, the viscosity during injection molding increases and results in a decrease in moldability.

A method for producing a second bonded magnet compound according to the present embodiment is characterized by including:
forming a bonded magnet additive by heat curing a thermosetting resin and a curing agent, the curing agent having a ratio of a number of reactive groups to a number of reactive groups of the thermosetting resin in a range from 2 to 11;
kneading the bonded magnet additive and a thermoplastic resin to form a bonded magnet resin composition; and
the step of kneading the bonded magnet resin composition and a magnetic powder formed by the above-described method for producing the phosphate-coated SmFeN-based anisotropic magnetic powder or the above-described magnetic powder to form a bonded magnet compound.

The step of forming a bonded magnet additive, and the thermosetting resin and curing agent used in that step are as described above.

The kneading step to form the bonded magnet resin composition, and the thermoplastic resin used in that step are as described above. Before being kneaded with the magnetic powder, the thermoplastic resin and a cured product of the thermosetting resin and the curing agent having a ratio of the number of reactive groups to the number of reactive group of the thermosetting resin in a range from 2 to 11 are melt kneaded in advance to form a melt-kneaded product. In the kneaded product that is formed, if the thermoplastic resin and cured product are melt kneaded in advance to form the kneaded product, the thermoplastic resin and the cured product may be fully compatible, partially compatible, or incompatible, and are preferably fully compatible.

In the bonded magnet resin composition formed by thoroughly kneading the cured product and the thermoplastic resin, if the thermoplastic resin is a crystalline resin, the melting point and crystallization temperature are reduced. As a result, the injection pressure of the bonded magnet compound is also reduced, the orientation ratio and magnetic properties of the formed bonded magnet are improved, and coercivity is also improved. The melting point is preferably lower than the melting point of the thermoplastic resin by 3.0° C. or more, and more preferably by 4.5° C. or more. Furthermore, the crystallization temperature is preferably lower than the crystallization temperature of the thermoplastic resin by 2.0° C. or more, and more preferably by 3.0° C. or more.

When polyamide 12 is used as the thermoplastic resin, the melting point (peak top) of the bonded magnet resin composition is preferably in a range from 160° C. to 177° C., and more preferably in a range from 170° C. to 175° C. Also, the difference between the peak top of the melting peak and the final melting point is preferably greater than 5.0° C., and more preferably greater than 5.5° C. Further, the heat quantity of the melting peak is preferably 50 mJ/mg or greater, and more preferably 55 mJ/mg or greater.

In the resin composition containing the bonded magnet additive and the thermoplastic resin, the blended amount of the bonded magnet additive is preferably in a range from 5 mass % to 50 mass %, and more preferably in a range from 10 mass % to 20 mass %. When the blended amount of the bonded magnet additive exceeds 50 mass %, the filling ratio of the magnetic powder is reduced, and when the blended amount of the bonded magnet additive is less than 5 mass %, the effect of reducing the melting point of the melt-kneaded product and the crystallization temperature is small, and the injection pressure during molding of the bonded magnet cannot be sufficiently reduced.

The kneading step to form the bonded magnet compound, and the magnetic powder used in that step are as described above.

In the method for producing the second bonded magnet compound according to the present embodiment, the filling ratio of the magnetic powder in the bonded magnet compound is preferably in a range from 75 mass % to 94 mass %, and more preferably in a range from 90 mass % to 93.5 mass %. When the filling ratio exceeds 94 mass %, the viscosity during injection molding increases and results in a decrease in moldability, and when the filling ratio is less than 75 mass %, the residual magnetic flux density of the bonded magnet decreases.

The content of the bonded magnet resin composition in the second bonded magnet compound of the present embodiment is preferably in a range from 6 mass % to 25 mass %, and more preferably in a range from 6.5 mass % to 10 mass %. When the content of the bonded magnet resin composition exceeds 25 mass %, the residual magnetic flux density of the bonded magnet decreases, and when the content thereof is less than 6 mass %, the viscosity during injection molding increases and results in a decrease in moldability.

The bonded magnet compound of the present embodiment is formed by the production method described above.

A method for producing a first bonded magnet according to the present embodiment is characterized by including:
forming a bonded magnet additive by heat curing a thermosetting resin and a curing agent, the curing agent having a ratio of a number of reactive groups to a number of reactive groups of the thermosetting resin in a range from 2 to 11;
kneading the bonded magnet additive, a magnetic powder formed by the above-described method for producing the phosphate-coated SmFeN-based anisotropic magnetic powder or the above-described magnetic powder, and a thermoplastic resin, to form a bonded magnet compound having a filling ratio of magnetic powder in the bonded magnet compound of 91.5 mass % or higher; and
injection molding the formed bonded magnet compound.

A method for producing a second bonded magnet according to the present embodiment is characterized by including:
forming a bonded magnet additive by heat curing a thermosetting resin and a curing agent, the curing agent having a ratio of a number of reactive groups to a number of reactive groups of the thermosetting resin in a range from 2 to 11;
forming a bonded magnet resin composition by kneading the bonded magnet additive and a thermoplastic resin;
kneading the bonded magnet resin composition and a magnetic powder formed by the above-described method for producing the phosphate-coated SmFeN-based anisotropic magnetic powder or the above-described magnetic powder to forma bonded magnet compound; and
injection molding the formed bonded magnet compound.

In the production method for these two bonded magnets, the step of forming the bonded magnet additive and the step of kneading to form a bonded magnet compound are as described above.

In the injection molding step, the bonded magnet compound is injection molded to form an injection molded product. The cylinder temperature of the injection molding machine need only be within a temperature range in which the bonded magnet compound melts, and is preferably 260° C. or lower from the perspective of suppressing heat induced magnetic degradation of the magnetic powder. The injection pressure need only be a pressure at which the molten compound can be injected, but for example, if the cylinder temperature of the injection molding machine is set to 230° C. and the molten bonded magnet compound is to be injection molded into a cavity having a diameter of 10 mm and a thickness of 7 mm, from the perspective of moldability, it is preferable that the cavity can be fully filled at an injection pressure of less than 250 MP a.

The first bonded magnet of the present embodiment is formed by, for example, the above-described method for producing the first bonded magnet according to the present embodiment, and is characterized by including a bonded magnet additive, a magnetic powder, and a thermoplastic resin, and by having a filling ratio of the magnetic powder of 91.5 mass % or higher. The first bonded magnet uses a bonded magnet compound having high fluidity and containing a bonded magnet additive, and thereby can be produced at a low injection pressure. As a result, magnetic degradation of the magnetic powder due to injection molding is suppressed, and the magnetic characteristics of the bonded magnet are improved.

In the first bonded magnet of the present embodiment, the filling ratio of the magnetic powder in the bonded magnet is 91.5 mass % or higher, preferably 91.8 mass % or higher, and more preferably 92.2 mass % or higher. The upper limit is not particularly limited, but is preferably 93.2 mass % or less, more preferably 92.8 mass % or less, and even more preferably 92.5 mass % or less. When the filling ratio exceeds 93.2 mass %, the viscosity during injection molding increases and results in a decrease in moldability.

In the first bonded magnet of the present embodiment, the content of the bonded magnet additive in the bonded magnet is preferably in a range from 0.5 mass % to 4.2 mass %, more preferably in a range from 0.9 mass % to 3.5 mass %, and even more preferably in a range from 0.9 mass % to 1.2 mass %. When the content of the bonded magnet additive exceeds 4.2 mass %, the residual magnetic flux density of the bonded magnet decreases, and when the content thereof is less than 0.5 mass %, the viscosity during injection molding increases and results in a decrease in moldability.

In the first bonded magnet of the present embodiment, the content of the thermoplastic resin in the bonded magnet is preferably 8.0 mass % or less, and more preferably 6.5 mass % or less. The lower limit is not particularly limited, but is preferably 4.2 mass % or higher, and more preferably 5.5 mass % or higher. When the addition amount of the thermoplastic resin exceeds 8.0 mass %, the residual magnetic flux density of the bonded magnet decreases, and when the addition amount is less than 4.2 mass %, the viscosity during injection molding increases and results in a decrease in moldability.

The orientation ratio in the first bonded magnet of the present embodiment is not particularly limited, but is preferably 98.3% or higher, and more preferably 99% or higher.

The residual magnetic flux density in the first bonded magnet of the present embodiment is not particularly limited, but when the magnetic powder is an SmFeN-based magnetic powder, the residual magnetic flux density is preferably 0.81 T or higher, and more preferably 0.82 T or higher. A high residual magnetic flux density can be achieved by using the bonded magnet resin additive of the present embodiment.

The coercivity of the first bonded magnet of the present embodiment is not particularly limited, but is preferably 1100 kA/m or greater, and more preferably 1200 kA/m or greater. High coercivity can be achieved by using the bonded magnet resin additive of the present embodiment.

The first bonded magnet of the present embodiment is produced by kneading the bonded magnet additive, the magnetic powder, and the thermoplastic resin, and thus the bonded magnet additive and the magnetic powder are each independently present.

The second bonded magnet of the present embodiment is formed, for example, by the above-described method for producing the second bonded magnet according to the present embodiment, and is characterized by including a bonded magnet resin composition and a magnetic powder. The second bonded magnet uses a bonded magnet compound having high fluidity and containing a bonded magnet resin composition, and thus can be produced at a low injection pressure. As a result, magnetic degradation of the magnetic powder due to injection molding is suppressed, and the magnetic characteristics of the bonded magnet are improved.

In the second bonded magnet of the present embodiment, the filling ratio of the magnetic powder in the bonded magnet is preferably in a range from 75 mass % to 94 mass %, and more preferably in a range from 90 mass % to 93.5 mass %. When the filling ratio exceeds 94 mass %, the viscosity during injection molding increases and results in a decrease in moldability, and when the filling ratio is less than 75 mass %, the residual magnetic flux density of the bonded magnet decreases.

In the second bonded magnet of the present embodiment, the content of the bonded magnet resin composition in the bonded magnet is preferably in a range from 6 mass % to 25 mass %, and more preferably in a range from 6.5 mass % to 10 mass %. When the content of the bonded magnet resin composition exceeds 25 mass %, the residual magnetic flux density of the bonded magnet decreases, and when the content thereof is less than 6 mass %, the viscosity during injection molding increases and results in a decrease in moldability.

The orientation ratio in the second bonded magnet of the present embodiment is not particularly limited, but is preferably 98.3% or higher, and more preferably 99% or higher.

The residual magnetic flux density in the second bonded magnet of the present embodiment is not particularly limited, but when the magnetic powder is an SmFeN-based magnetic powder, the residual magnetic flux density is preferably 0.81 T or higher, and more preferably 0.82 T or higher. A high residual magnetic flux density can be achieved by using the bonded magnet resin composition of the present embodiment containing a melt-kneaded product of a thermoplastic resin and a cured product, the cured product containing a thermosetting resin and a curing agent.

The coercivity of the second bonded magnet of the present embodiment is not particularly limited, but is preferably 1150 kA/m or greater, and more preferably 1200 kA/m or greater. High coercivity can be achieved by using the bonded magnet resin composition of the present embodiment containing a melt-kneaded product of a thermoplastic resin and a cured product, the cured product containing a thermosetting resin and a curing agent.

The second bonded magnet of the present embodiment is produced by kneading the bonded magnet resin composition and the magnetic powder, and thus the bonded magnet resin composition and the magnetic powder are each independently present.

### EXAMPLES

### Example 1

5.0 kg of FeSOa₇·H₂O was mixed and dissolved in 2.0 kg of pure water. In addition, 0.49 kg of Sm₂O₃ and 0.74 kg of 70% sulfuric acid were added and the mixture was stirred well to completely dissolve the material. Subsequently, pure water was added to the resulting solution to adjust the solution such that the final Fe concentration was 0.726 mol/L and the final Sm concentration was 0.112 mol/L, and thereby an SmFe sulfuric acid solution was prepared.

### Precipitation Step

Into 20 kg of pure water maintained at a temperature of 40° C., the entire amount of the prepared SmFe sulfuric acid solution was added dropwise while being stirred over a period of 70 minutes from the startup of the reaction, and at the same time, a 15% ammonia solution was added dropwise to adjust the pH to a range from 7 to 8. As a result, a slurry containing SmFe hydroxide was formed. The formed slurry was washed with pure water by decantation, after which the hydroxide was solid-liquid separated. The separated hydroxide was dried in an oven at 100° C. for 10 hours.

### Oxidation Step

The hydroxide formed in the precipitation step was fired at 1000° C. in air for 1 hour. The fired hydroxide was cooled, after which a red SmFe oxide was formed as a raw material powder.

### Pretreatment Step

100 g of the SmFe oxide was placed in a steel container such that the bulk thickness was 10 mm. The container was inserted into a furnace, and the pressure was reduced to 100 Pa, after which the temperature was increased to the pretreatment temperature of 850° C. while hydrogen gas was being introduced, and this state was maintained for 15 hours. The oxygen concentration was measured by the non-dispersive infrared absorption method (ND-IR) (using the EMGA-820 available from HORIBA, Ltd.) and was found to be 5 mass %. Through this, it was found that the oxygen bonded to Sm was not reduced, and a black partial oxide in which 95% of the oxygen bonded to Fe was reduced was formed.

### Reduction Step

60 g of the partial oxide formed in the pretreatment step and 19.2 g of metal calcium having an average particle size of approximately 6 mm were mixed and inserted into a furnace. The inside of the furnace was evacuated to create a vacuum state, after which argon gas (Ar gas) was introduced. Fe—Sm alloy particles were formed by increasing the temperature to 1045° C. and maintaining that temperature for 45 minutes.

### Nitriding Step

Subsequently, the temperature inside the furnace was cooled to 100° C., after which the furnace was evacuated to a vacuum state, the temperature was increased to 450° C. while nitrogen gas was being introduced, and that state was maintained for 23 hours, and as a result, a clump-shaped product containing magnetic particles was formed.

### Rinsing Step

The clump-shaped product formed in the nitriding step was put into 3 kg of pure water and the mixture was stirred for 30 minutes. The formed solution was left standing, after which the supernatant was drained by decanting. The process of putting into pure water, stirring and decanting was repeated 10 times. Subsequently, 2.5 g of 99.9% acetic acid was added, and the mixture was stirred for 15 minutes. The formed solution was left standing, after which the supernatant was drained by decanting. The process of putting into pure water, stirring and decanting was repeated twice, after which the formed product was dehydrated and dried, and then subjected to mechanical crushing, and thereby an SmFeN-based anisotropic magnetic powder (average particle size of 3 μm) was formed.

Phosphate treatment Step

A phosphate treatment solution was prepared by mixing 85% orthophosphoric acid, sodium dihydrogen phosphate, and sodium molybdate dihydrate at a weight ratio of 1:6:1 (85% orthophosphoric acid:sodium dihydrogen phosphate:sodium molybdate dihydrate), and then adjusting the pH to 2 and the PO₄ concentration to 20 mass % using pure water and dilute hydrochloric acid. Subsequently, 1000 g of the SmFeN-based anisotropic magnetic powder formed in the rinsing step was put into hydrogen chloride and 70 g of dilute hydrochloric acid, and the mixture was stirred for 1 minute to remove the surface oxide film and contaminants, after which drainage and water injection were repeated until the conductivity of the supernatant became 100 μS/cm, and a slurry containing 10 mass % of the SmFeN-based anisotropic magnetic powder was formed. While the formed slurry was stirred, a total amount of 100 g of the prepared phosphate treatment solution was put into the treatment tank, after which the pH of the phosphate treatment reaction slurry was controlled to a range of 2.0±0.1 by adding 6 wt. % of hydrochloric acid as needed, and this state was maintained for 30 minutes. Subsequently, suction filtration, dehydration, and vacuum drying were carried out to form a phosphate-coated SmFeN-based anisotropic magnetic powder.

### Example 2

A phosphate-coated SmFeN-based anisotropic magnetic powder was formed in the same manner as in Example 1 with the exception that a phosphate treatment solution having a pH adjusted to 2.5 was prepared, and the pH of the phosphate treatment reaction slurry was controlled to a range of 2.5±0.1.

### Example 3

A phosphate-coated SmFeN-based anisotropic magnetic powder was formed in the same manner as in Example 1 with the exception that a phosphate treatment solution having a pH adjusted to 3 was prepared, and the pH of the phosphate treatment reaction slurry was controlled to a range of 3.0±0.1.

### Example 4

A phosphate-coated SmFeN-based anisotropic magnetic powder was formed in the same manner as in Example 1 with the exception that a phosphate treatment solution having a pH adjusted to 3.5 was prepared, and the pH of the phosphate treatment reaction slurry was controlled to a range of 3.5±0.1.

### Example 5

A phosphate-coated SmFeN-based anisotropic magnetic powder was formed in the same manner as in Example 1 with the exception that a phosphate treatment solution having a pH adjusted to 1.5 was prepared, and the pH of the phosphate treatment reaction slurry was controlled to a range of 1.5±0.1.

### Example 6

A phosphate-coated SmFeN-based anisotropic magnetic powder was formed in the same manner as in Example 1 with the exception that a phosphate treatment solution having a pH adjusted to 4 was prepared, and the pH of the phosphate treatment reaction slurry was controlled to a range of 4.0±0.1.

### Comparative Example 1

Steps up to the rinsing step were implemented in the same manner as in Example 1 to form a magnetic powder. A phosphate treatment solution was prepared by mixing 85% orthophosphoric acid, sodium dihydrogen phosphate, and sodium molybdate dihydrate at a weight ratio of 1:6:1 (85% orthophosphoric acid:sodium dihydrogen phosphate:sodium molybdate dihydrate), and then adjusting the pH to 2.5 and the PO₄ concentration to 20 mass % using pure water and dilute hydrochloric acid. Subsequently, 1000 g of the SmFeN-based anisotropic magnetic powder formed in the rinsing step was putting into dilute hydrochloric acid containing 70 g of hydrogen chloride, and the mixture was stirred for 1 minute to remove the surface oxide film and contaminants, after which drainage and water injection were repeated until the conductivity of the supernatant became 100 μS/cm or less, and a slurry containing 10 mass % of the SmFeN-based anisotropic magnetic powder was formed. While the formed slurry was stirred, a total amount of 100 g of the prepared phosphate treatment solution was added into the treatment vessel. The pH of the phosphate treatment reaction slurry was increased from 2.5 to 6 over 5 minutes. After 15 minutes of stirring, suction filtration, dehydration, and vacuum drying were carried out to form a phosphate-coated SmFeN-based anisotropic magnetic powder.

### Comparative Example 2

A phosphate-coated SmFeN-based anisotropic magnetic powder was formed in the same manner as in Comparative Example 1 with the exception that the pH of the phosphate treatment solution was adjusted to 3.5. Here, the pH of the phosphate treatment reaction slurry was increased from 3.5 to 6 over 15 minutes.

### Comparative Example 3

### Reduction Step 2

A crucible in which a mixed powder of 52.5 g of iron powder having an average particle size (D50) of approximately 50 μm, 21.3 g of a samarium oxide powder having an average particle size (D50) of 3 μm, and 10.5 g of metal calcium were supplied was inserted into a furnace. The inside of the furnace was evacuated to create a vacuum state, after which argon gas (Ar gas) was introduced. Fe—Sm alloy particles were formed by increasing the temperature to 1150° C. and maintaining that temperature for 5 hours.

### Nitriding Step 2

Subsequently, the Fe—Sm alloy particles were heat treated at 420° C. for 23 hours in an ammonia-hydrogen mixed gas, and a clump-shaped product containing the magnetic particles was formed.

### Rinsing Step 2

The clump-shaped product formed in the nitriding step was put into 3 kg of pure water and the mixture was stirred for 30 minutes. The formed solution was left standing, after which the supernatant was drained by decanting. The process of putting into pure water, stirring and decanting was repeated 10 times. Subsequently, 2.5 g of 99.9% acetic acid was added, and the mixture was stirred for 15 minutes. The stirred solution was left standing, after which the supernatant was drained by decanting. The process of putting into pure water, stirring and decanting was repeated twice.

Subsequently, the formed product was dehydrated and dried, and thereby an SmFeN-based anisotropic magnetic powder (average particle size of 30 μm) was formed.

Phosphate treatment Step 2

15 g of the formed magnetic powder, 0.44 g of an 85% orthophosphoric acid aqueous solution, 100 mL of isopropanol (IPA), and 200 g of alumina beads having a diameter of 10 mm were stored in a glass jar, the glass jar was sealed and the contents were ground for 120 minutes using a vibrating ball mill. Subsequently, the slurry was filtered, and then vacuum dried at 100° C., and a phosphate-coated SmFeN-based anisotropic magnetic powder (average particle size of 1.5 μm) was formed.

### Magnetic Powder Evaluation

Residual Magnetic Flux Density (Br) and Coercivity (iHc) of Magnetic Powder

The magnetic properties (residual magnetization Gr, intrinsic coercivity iHc) of the phosphate-coated SmFeN-based anisotropic magnetic powders formed in Examples 1 to 6 and Comparative Examples 1 to 3 were measured using a vibrating-sample magnetometer (VSM) (available from Riken Denshi Co., Ltd., model: BHV-55). In addition, the residual magnetic flux density Br (unit: kG) was calculated from the residual magnetization Gr (unit: emu/g) using the equation of (Br=4×π×ρ×σr, ρ: density=7.66 g/cm 3). The results are shown in Table 1.

### DSC Exothermic Onset Temperature

The exothermic onset temperature of each of the phosphate-coated SmFeN-based anisotropic magnetic powders formed in Examples 1 to 6 and Comparative Examples 1 to 3 was measured by weighing 20 mg of the phosphate-coated SmFeN-based anisotropic magnetic powder, and subjecting the powder to DSC analysis using a high-temperature differential scanning calorimeter (DSC6300, available from Hitachi High-Tech Science Corporation) under measurement conditions including an air atmosphere (200 mL/min), a temperature from room temperature to 400° C. (heating rate: 20° C./min), and a reference of alumina (20 mg). The DSC results are shown in Table 1. A high exothermic onset temperature means that the phosphate coating is more densely formed because heat generation due to oxidation does not easily occur.

### α-Fe Peak Height Ratio

The XRD pattern of each of the phosphate-coated SmFeN-based anisotropic magnetic powders formed in Examples 1 to 6 and Comparative Examples 1 to 3 was measured using a powder X-ray crystal diffractometer (available from Rigaku Corporation, X-ray wavelength: CuKa1). The diffraction peak intensity of the (110) plane of α-Fe was divided by the peak intensity of the (300) plane of Sm₂Fe₁₇N₃, and then multiplied by 10000, and the resulting value was used as the α-Fe peak height ratio. The results are shown in Table 1. A low α-Fe peak height ratio means that the content of α-Fe, which is an impurity, is low.

### PO₄ Adhesion Amount

The P concentration in each of the phosphate-coated SmFeN-based anisotropic magnetic powders formed in Examples 1 to 6 and Comparative Examples 1 to 3 was measured using inductively coupled plasma atomic emission spectroscopy (ICP-AES), and the P concentration was converted to the molecular weight of PO₄ to determine the adhesion amount of PO₄. The results are shown in Table 1.

### Total Carbon Content

The total carbon (TC) content in each of the phosphate-coated SmFeN-based anisotropic magnetic powders formed in Examples 1 to 6 and Comparative Examples 1 to 3 was measured using a combustion catalytic oxidation-type total organic carbon (TOC) meter (available from Shimadzu Corporation, model: SSM-5000A). The results are shown in Table 1.

TABLE 1

| | | pH | | | | | | |
|---|---|---|---|---|---|---|---|---|
| | | Adjustment | | | DSC | | | |
| | | During | | | Exothermic | PO₄ | aFe | |
| | | Phosphoric | | | Onset | Adhesion | Peak Height | |
| | Treatment | Acid | Br | iHc | Temperature | Amount | Ratio | |
| | Medium | Treatment | kG | kOe | ° C. | wt % | (110/300) | TC(ppm) |
| Example 1 | Water | 2 | 13.0 | 19.2 | 204.9 | 1.4 | 62 | 780 |
| Example 2 | Water | 2.5 | 13.0 | 19.8 | 210.1 | 1.1 | 41 | 280 |
| Example 3 | Water | 3 | 13.0 | 18.9 | 207.5 | 1.0 | 91 | 240 |
| Example 4 | Water | 3.5 | 12.9 | 17.5 | 203 | 0.9 | 97 | 240 |
| Example 5 | Water | 1.5 | 11.2 | 19.9 | >210 | 4.0 | 99 | 830 |
| Example 6 | Water | 4 | 13.2 | 16.0 | 170.5 | 0.6 | 92 | 240 |
| Comparative | Water | No pH | 13.1 | 15.2 | 165.2 | 0.5 | 229 | 280 |
| Example 1 | | adjustment | | | | | | |
| | | (2.5→6) | | | | | | |
| Comparative | Water | No pH | 13.1 | 14.7 | 158.2 | 0.4 | 236 | 100 |
| Example 2 | | adjustment | | | | | | |
| | | (3.5→6) | | | | | | |
| Comparative | IPA | No pH | 11.5 | 12.3 | 100.6 | 1.7 | 259 | 1300 |
| Example 3 | | adjustment | | | | | | |

From Table 1, it is clear that in comparison to the coercivity (iHc) values of Comparative Examples 1 and 2 in which the pH was not adjusted in the water solvent, the coercivity (iHc) was higher in Examples 1 to 6 in which the pH was adjusted in the water solvent during the phosphate treatment. The coercivity was the lowest in Comparative Example 3 in which the pH was not adjusted in the isopropanol solvent.

### SEM Analysis

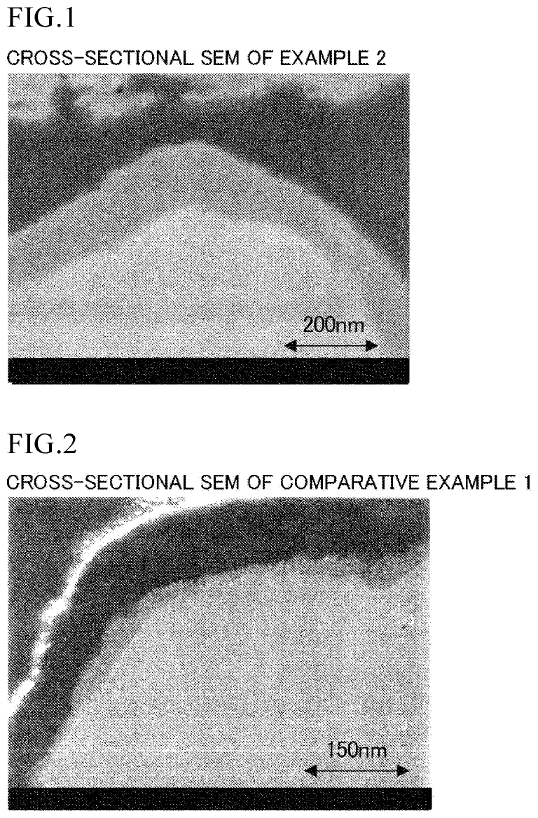

Cross-sectional SEM images of the magnetic powders formed in Example 2 and Comparative Example 1 are shown in FIGS. 1 and 2. In Example 2, a thicker phosphate coating was formed on the surface of the SmFeN-based anisotropic magnetic powder than in Comparative Example 1.

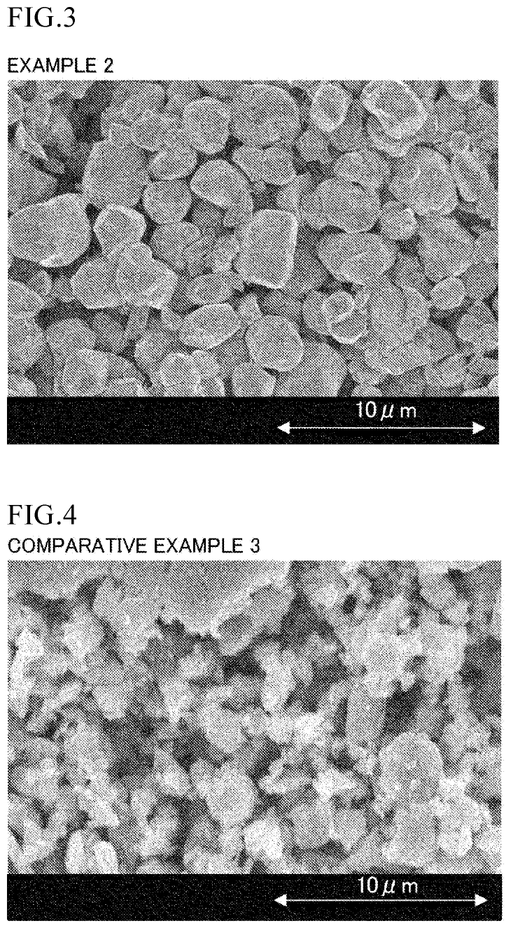

SEM images of the magnetic powders formed in Example 2 and Comparative Example 3 are shown in FIGS. 3 and 4. The particle size of the magnetic powders was measured in dry conditions using a laser diffraction-type particle size distribution measurement device, and the results are shown in FIG. 5. The vertical axis of FIG. 5 shows a volume-based frequency distribution. In Comparative Example 3, grinding was implemented in parallel with the phosphate treatment, and thus the uniformity of the particle size distribution was inferior. Magnetic powder having a uniform particle size was formed in Example 2.

### STEM-EDX Mapping

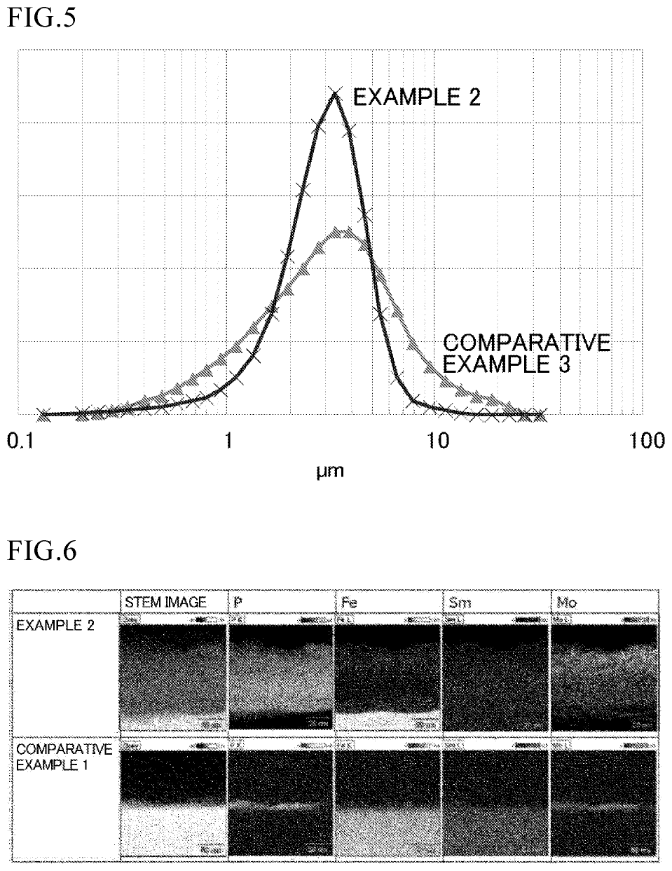

The magnetic powders formed in Example 2 and Comparative Example 1 were respectively dispersed in an epoxy resin and solidified, and then cross-sectioned with a cross-section polisher to form a cross-section sample for measurement. A STEM image (acceleration voltage of 200 kV) of each of the formed samples was measured using a scanning transmission electron microscope (STEM; available from JEOL. Ltd.) and an energy dispersive X-ray analyzer (EDX; available from JEOL, Ltd.). FIG. 6 shows the STEM-EDX mapping analysis results (elements: P, Fe, Sm, Mo, N).

### STEM-EDX Line Profile Analysis

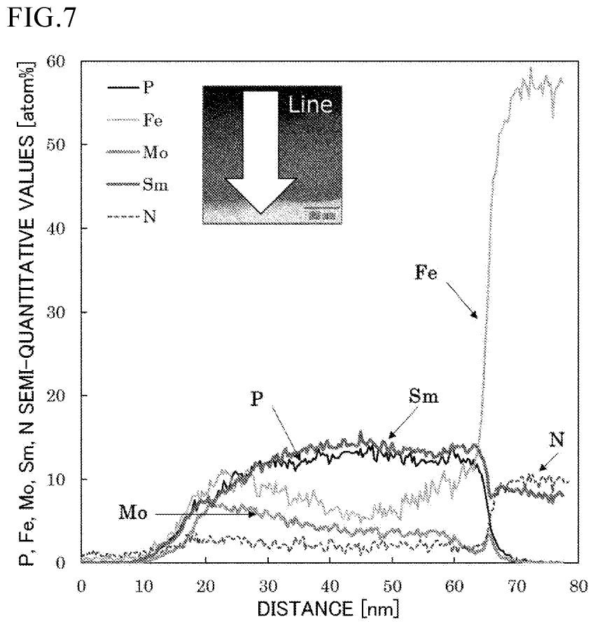

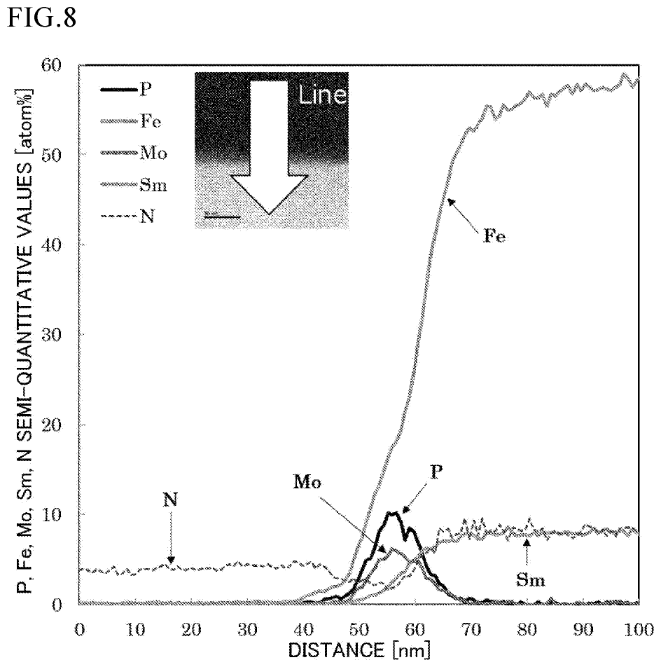

The magnetic powders formed in Example 2 and Comparative Example 1 were subjected to an EDX line profile analysis corresponding to the arrow at the interface between the phosphate coating and the SmFeN-based anisotropic magnetic powder, and the results of the EDX line profile analysis are presented in FIGS. 7 and 8. In FIG. 7, with respect to the magnetic powder of Example 2, a region in which the atomic ratio of Sm and N is substantially the same is observed across a distance ranging from 65 nm to near 80 nm, and this region is considered to correspond to the SmFeN-based anisotropic magnetic powder, which is the base. A distribution of P is observed across a distance from 10 nm to near 65 nm, and this region is considered to correspond to the phosphate coating (metal=Sm, Fe, Mo). In addition, in the region corresponding to the phosphate coating, in particular, the region in which the Sm concentration is high is observed particularly at a distance from 30 nm to near 65 nm. In this region, the ratio of Sm is the highest among the metal elements, and the main component is presumed to be samarium phosphate. Additionally, Mo has a peak at a position near 65 nm corresponding to the region of the outermost surface of the SmFeN-based anisotropic magnetic powder, and gradually increases towards the surface of the phosphate coating. In this manner, it was confirmed that the phosphate coating of Example 2 contained samarium phosphate as a main component and had a lower Fe atomic concentration than Comparative Example 1.

In FIG. 8, with regard to the magnetic powder of Comparative Example 1, a distribution of P is observed across a distance from 50 nm to near 70 nm, and this region corresponds to the phosphate coating (metal=Sm, Fe, Mo). In this region, the ratio of Fe is the highest, and the main component is presumed to be iron phosphate. Also, the graph shape of Mo is similar to that for P, and unlike the magnetic powder of Example 2, Mo and P are present in a substantially constant composition.

### Example 7

Oxidation Step After Phosphate treatment

1000 g of the phosphate-coated SmFeN-based anisotropic magnetic powder formed in Example 2 was gradually heated from room temperature in a mixed gas (oxygen concentration of 4%, 5 L/min) atmosphere of nitrogen and air, and heat treated at a maximum temperature of 170° C. for 8 hours, and an oxidation-treated SmFeN-based anisotropic magnetic powder was formed.

### Example 8

An oxidation-treated SmFeN-based anisotropic magnetic powder was formed in the same manner as in Example 7 with the exception that the heat treatment temperature in the oxidation treatment step was changed from 170° C. to 200° C.

### Example 9

An oxidation-treated SmFeN-based anisotropic magnetic powder was formed in the same manner as in Example 7 with the exception that the heat treatment temperature in the oxidation treatment step was changed from 170° C. to 230° C.

### Comparative Example 4

Oxidation Step after Phosphate Treatment

1000 g of the phosphate-coated SmFeN-based anisotropic magnetic powder formed in Comparative Example 1 was gradually heated from room temperature in a mixed gas (oxygen concentration of 4%, 5 L/min) atmosphere of nitrogen and air, and heat treated at a maximum temperature of 170° C. for 8 hours, and an oxidation-treated SmFeN-based anisotropic magnetic powder was formed.

### Comparative Example 5

Oxidation Step after Phosphate Treatment

15 g of the phosphate-coated SmFeN-based anisotropic magnetic powder formed in Comparative Example 3 was gradually heated from room temperature in a mixed gas (oxygen concentration of 4%, 5 L/min) atmosphere of nitrogen and air, and heat treated at a maximum temperature of 150° C. for 8 hours, and an oxidation-treated SmFeN-based anisotropic magnetic powder was formed.

### Magnetic Powder Evaluation

Coercivity (iHc)

The magnetic properties (intrinsic coercivity iHc) of the oxidation-treated SmFeN-based anisotropic magnetic powders formed in Examples 7 to 9 and Comparative Examples 4 and 5 were measured using a vibrating-sample magnetometer (VSM). The results are shown in Table 2.

### Silica Treatment Step

Each of the oxidation-treated SmFeN-based anisotropic magnetic powders formed in Examples 7 to 9 and Comparative Examples 4 and 5 was mixed with ethyl silicate 40 and 12.5 wt. % ammonia water at a weight ratio of 97.8:1.8:0.4 using a mixer. The mixture was heated at 200° C. in vacuum state, and an SmFeN-based anisotropic magnetic powder having a silica thin film formed on the particle surface was formed.

Furthermore, each of the SmFeN-based anisotropic magnetic powders formed in Example 2 and Comparative Examples 1 and 3 and not oxidation treated were treated with the same conditions, and SmFeN-based anisotropic magnetic powders having a silica thin film formed on the particle surface were formed (the formed powders were used as Example 10, Comparative Example 6, and Comparative Example 7, respectively).

### Silane Coupling Treatment Step

The SmFeN-based anisotropic magnetic powder on which a silica thin film was formed and 12.5 wt. % ammonia water were mixed in a mixer, after which an ethanol solution of 50 wt. % 3-aminopropyltriethoxysilane was mixed therewith using a mixer. The weight ratio of the SmFeN-based anisotropic magnetic powder on which the silica thin film was formed, the 12.5 wt. % ammonia water and the ethanol solution of 50 wt. % 3-aminopropyltriethoxysilane was 99:0.2:0.8, respectively. The mixture was dried in a nitrogen atmosphere at 100° C. for 10 hours, and a silane-coupling treated SmFeN-based anisotropic magnetic powder was formed.

### Kneading and Molding Step

The silane-coupling treated SmFeN-based anisotropic magnetic powder, 12 nylon resin, and an antioxidant were mixed at a weight ratio of 91:8.5:0.5, respectively, and kneaded with a twin-screw extruder to form a bonded magnet compound. The kneading temperature at this time was 210° C.

### Molding Step

The bonded magnet compound was heated to 240° C. in the barrel of the injection molding machine, and while a magnetic field was applied at an applied magnetic field of 9 kOe, the molten bonded magnet compound was injection molded into a mold for which the temperature was adjusted to 90° C., and a cylindrical bonded magnet molded article having a diameter (D) of 10 mm and a height (t) of 7 mm was formed for use in a water resistance evaluation.

### Magnet Evaluation Step

Magnet iHc, iHc Reduction Rate

The bonded magnet molded articles formed in Examples 7, 8, 9, and 10 and Comparative Examples 4, 5, 6, and 7 were each placed in an air-core coil and then magnetized with a magnetizing magnetic field of 60 kOe, after which the magnetic properties (magnet-inherent coercivity iHc after molding) were measured using a BH tracer. The iHc reduction rate in the magnet forming process was also determined using the equation (oxidized magnetic powder iHc−molded magnet iHc)÷oxidized magnetic powder iHc×100. Note that for Example 10 and Comparative Examples 6 and 7, the iHc reduction rate was determined using the iHc value of the pre-oxidized magnetic powder in place of the iHc of the oxidized magnetic powder. The results are shown in Table 2.

TABLE 2

| | | | Pre- | | | |
|---|---|---|---|---|---|---|
| | | | oxidation | Oxidized | | |
| | Magnetic | | Magnetic | Magnetic | Molded | iHc |
| | Powder | | Powder | Powder | Magnet | Reduction |
| | Production | Oxidation | iHc | iHc | iHc | Rate |
| | Conditions | Temperature | kOe | kOe | kOe | % |
| Example 7 | Example 2 | 170° C. | 19.8 | 20.2 | 18.9 | 6.4 |
| Example 8 | Example 2 | 200° C. | 19.8 | 20.2 | 18.7 | 7.4 |
| Example 9 | Example 2 | 230° C. | 19.8 | 18.1 | 16.9 | 6.6 |
| Example 10 | Example 2 | — | 19.8 | — | 16.1 | 18.7 |
| Comparative | Comparative | 170° C. | 15.2 | 15.8 | 14.8 | 2.6 |
| Example 4 | Example 1 | | | | | |
| Comparative | Comparative | 150° C. | 12.3 | 12.4 | 11.4 | 7.3 |
| Example 5 | Example 3 | | | | | |
| Comparative | Comparative | — | 15.2 | — | 14.2 | 6.6 |
| Example 6 | Example 1 | | | | | |
| Comparative | Comparative | — | 12.3 | — | 11.1 | 9.8 |
| Example 7 | Example 3 | | | | | |

From Table 2, it is clear that the bonded magnets formed in Examples 7, 8, 9, and had higher coercivity than the bonded magnets formed in Comparative Examples 4, 6, and 7. Furthermore, the bonded magnets formed in Examples 7, 8, and 9, which were oxidation treated after the phosphate coating was formed, had even higher coercivity than that of Example 10. The pH of the magnetic powder of Comparative Example 4 was not adjusted when the phosphate coating was formed, and therefore even though the oxidation treatment was implemented after the phosphate coating was formed, the improvement in coercivity of the bonded magnet was minimal in comparison to Comparative Example 6. Similarly, in Comparative Example 5, the improvement in coercivity in the bonded magnet was little compared to Comparative Example 7. From this, it was confirmed that the effect of the oxidation treatment is significant for an SmFeN-based magnetic powder phosphate-treated under predetermined conditions.

### INDUSTRIAL APPLICABILITY

According to the production method of the present invention, a phosphate-coated SmFeN-based anisotropic magnetic powder having good coercivity can be formed. The formed magnetic powder can be used as a sintered magnet or a bonded magnet.

1-19. (canceled)

20. A method for producing a phosphate-coated SmFeN-based anisotropic magnetic powder, the method comprising:
a phosphate treatment of adding an inorganic acid to a slurry containing an SmFeN-based anisotropic magnetic powder, water, and a phosphate compound to adjust a pH of the slurry to a range of 1 to 4.5 to form a phosphate-coated SmFeN-based anisotropic magnetic powder having a surface coated with a phosphate.

21. The method for producing a phosphate-coated SmFeN-based anisotropic magnetic powder according to claim 20, wherein a content of a phosphate in the phosphate-coated SmFeN-based anisotropic magnetic powder is greater than 0.5 mass %.

22. The method for producing a phosphate-coated SmFeN-based anisotropic magnetic powder according to claim 20, wherein
in the phosphate-coated SmFeN-based anisotropic magnetic powder formed in the phosphate treatment, a phosphate coating present on a surface of the phosphate-coated SmFeN-based anisotropic magnetic powder has a region in which an Sm atomic concentration is higher than an Sm atomic concentration in the SmFeN-based anisotropic magnetic powder.

23. The method for producing a phosphate-coated SmFeN-based anisotropic magnetic powder according to claim 20, wherein in the phosphate treatment, the adjusting of the pH of the slurry is carried out over a period of 10 minutes or longer.

24. The method for producing a phosphate-coated SmFeN-based anisotropic magnetic powder according to claim 20, wherein in the phosphate treatment, the pH of the slurry is adjusted to a range of 1.6 to 3.9.

25. The method for producing a phosphate-coated SmFeN-based anisotropic magnetic powder according to claim 20, further comprising, after the phosphate treatment, oxidation by heat treating the phosphate-coated SmFeN-based anisotropic magnetic powder in an oxygen-containing atmosphere at a temperature in a range of 150° C. to 250° C.

26. The method for producing a phosphate-coated SmFeN-based anisotropic magnetic powder according to claim 20, wherein the phosphate compound used in the phosphate treatment includes an inorganic phosphate compound.

27. A phosphate-coated SmFeN-based anisotropic magnetic powder having an exothermic onset temperature according to differential scanning calorimetry (DSC) of 170° C. or higher, and a phosphate content of greater than 0.5 mass %.

28. The phosphate-coated SmFeN-based anisotropic magnetic powder according to claim 27, wherein in an XRD diffraction pattern of the phosphate-coated SmFeN-based anisotropic magnetic powders, a ratio (I)/(II) of a diffraction peak intensity (I) of a (110) plane of αFe to a diffraction peak intensity (II) of a (300) plane is 2.0×10⁻² or less.

29. The phosphate-coated SmFeN-based anisotropic magnetic powder according to claim 27, wherein a content of carbon in the phosphate-coated SmFeN-based anisotropic magnetic powder is 1000 ppm or less.

30. The phosphate-coated SmFeN-based anisotropic magnetic powder according to claim 27, wherein a phosphate coating present on a surface of the phosphate-coated SmFeN-based anisotropic magnetic powder has a region in which an Sm atomic concentration is higher than an Sm atomic concentration in the SmFeN-based anisotropic magnetic powder.

31. A method for producing a bonded magnet compound, the method comprising:
forming a bonded magnet additive by heat curing a thermosetting resin and a curing agent, wherein a ratio of a number of reactive groups in the curing agent to a number of reactive groups in the thermosetting resin is in a range of 2 to 11; and
kneading the bonded magnet additive, the phosphate-coated SmFeN-based anisotropic magnetic powder according to claim 27, and a thermoplastic resin to form a bonded magnet compound in which a filling ratio of the phosphate-coated SmFeN-based anisotropic magnetic powder in the bonded magnet compound is 91.5 mass % or higher.

32. A method for producing a bonded magnet compound, the method comprising:
forming a bonded magnet additive by heat curing a thermosetting resin and a curing agent, wherein a ratio of a number of reactive groups in the curing agent to a number of reactive groups in the thermosetting resin is in a range of 2 to 11;
kneading the bonded magnet additive and a thermoplastic resin to form a bonded magnet resin composition; and
kneading the bonded magnet resin composition and the phosphate-coated SmFeN-based anisotropic magnetic powder according to claim 27 to form a bonded magnet compound.

33. The method for producing a bonded magnet compound according to claim 31, wherein the thermoplastic resin is a nylon resin.

34. The method for producing a bonded magnet compound according to claim 31, wherein a particle size distribution of the phosphate-coated SmFeN-based anisotropic magnetic powder is a mono-dispersion.

35. The method for producing a bonded magnet compound according to claim 31, wherein the phosphate-coated SmFeN-based anisotropic magnetic powder comprises Sm, Fe, and N.

36. A bonded magnet compound formed by the method according to claim 31.

37. A method for producing a bonded magnet, the method comprising:
forming a bonded magnet additive by heat curing a thermosetting resin and a curing agent, wherein a ratio of a number of reactive groups in the curing agent to a number of reactive groups in the thermosetting resin is in a range of 2 to 11;
kneading the bonded magnet additive, the phosphate-coated SmFeN-based anisotropic magnetic powder according to claim 27, and a thermoplastic resin to form a bonded magnet compound in which a filling ratio of the phosphate-coated SmFeN-based anisotropic magnetic powder in the bonded magnet compound is 91.5 mass % or higher; and
injection molding the formed bonded magnet compound.

38. A method for producing a bonded magnet, the method comprising:
forming a bonded magnet additive by heat curing a thermosetting resin and a curing agent, wherein a ratio of a number of reactive groups in the curing agent to a number of reactive groups in the thermosetting resin in a range of 2 to 11;
kneading the bonded magnet additive and a thermoplastic resin to form a bonded magnet resin composition;
kneading the bonded magnet resin composition and the phosphate-coated SmFeN-based anisotropic magnetic powder according to claim 27 to form a bonded magnet compound; and
injection molding the formed bonded magnet compound.

39. A bonded magnet formed by the method according to claim 36.
